(19) United States
(12) Patent Application Publication
(10) Pub. No.: US 2014/0067501 A1
(43) Pub. Date: Mar. 6, 2014

(54) Social Network for Distributing Multimedia Content

(71) Applicant: Tom Rozenvasser, Tel Aviv (IL)

(72) Inventor: Tom Rozenvasser, Tel Aviv (IL)

(21) Appl. No.: 14/017,571

(22) Filed: Sep. 4, 2013

Related U.S. Application Data
(60) Provisional application No. 61/696,323, filed on Sep. 4, 2012.

(51) Int. Cl. G06Q 30/02

(52) U.S. Cl. CPC G06Q 30/0215
USPC 705/14.17

(57) ABSTRACT

An electronic system and method for distribution of multimedia content programs over an electronic communication network to a user in a social network. The social network enables users to register and connect with other users. Users get paid for watching content, by receiving a revenue share of the advertisements displayed in conjunction with the selected content. A user may also browse the content watched by any of his friends on the social network, and choose to watch the same content. In this case, the user gets compensated for watch a content program with advertisement and the friend also gets compensated for the referral.

### CROSS REFERENCE TO OTHER APPLICATIONS

The claims priority of U.S. Provisional Patent Application No. 61/696,323 filed on Sep. 4, 2012 and incorporated herein by reference.

### TECHNICAL FIELD

The present invention relates to a system and method for distributing multimedia content in general, and in particular to distributing multimedia content over a social network.

### BACKGROUND ART

Accessing multimedia content such as video, graphics, pictures, text, sound, games or applications is available today on a myriad of devices such as televisions, interactive televisions, televisions connected to set-top boxes, televisions connected to streamers, computers, laptops, tablets, game consoles, smartphones etc.

The multimedia content can be provided for free or for a fee and can also be supported by sponsored messages (advertisement etc.). Content piracy and illegal sharing and distribution of intellectually protected content are also a common phenomenon today. Online piracy of content stems for various reasons including the unwillingness of many users to pay for online content and the easy access of pirated content over peer-to-peer networks, bit torrents sites etc.

There is thus a great need in the content industry to provide users with legal access to multimedia content while making a profit.

### SUMMARY OF INVENTION

It is an object of the present invention to provide a social network for distribution of multimedia content.

It is another object of the present invention to provide a social network for distribution of multimedia content where a user can see what his friends on the social network are currently watching or what they have watched.

It is a further object of the present invention to provide a social network for distribution of multimedia content supported by sponsored messages.

It is yet a further object of the present invention to provide a social network for distribution of multimedia content while sharing the revenue from the sponsored messages with users who have watched the sponsored messages.

It is yet another object of the present invention to provide a social network for distribution of multimedia content while sharing the revenue from the sponsored messages with users who have referred other users to watch the sponsored messages.

It is yet a further object of the present invention to provide a social network where users can promote multimedia content programs they viewed, have viewed or intend to view.

The present invention relates to a method for distribution of multimedia content programs over an electronic communication network to a user in a social network, comprising:

(i) creating a program database with a plurality of multimedia content programs comprising video, graphics, animations, pictures, text, sound, games, applications or any combination thereof;

(ii) creating a user database comprising user identification information;

(iii) enabling the user to electronically communicate with one or more users in the social network to form social network friends;

(iv) saving in the user database for each user an activity log of the multimedia content programs currently viewed and the multimedia content programs viewed in the past;

(v) selecting by the user via an interactive electronic communication device a multimedia content program to view either from the plurality of multimedia content programs or from the activity log associated with a friend;

(vi) providing the user access over the electronic communication network to the selected multimedia content program together with one or more sponsored messages;

(vii) electronically crediting the user's automated bank resource with a first monetary revenue for watching the one or more sponsored messages;

(viii) electronically crediting a user's friend automated bank resource with a second monetary revenue if the selected multimedia content program was selected from an activity log associated with the user's friend.

The present invention further relates to an electronic system comprising a memory and processor for distribution of multimedia content programs over an electronic communication network to a user in a social network, comprising:

(i) a program database for storing a plurality of multimedia content programs comprising video, graphics, animations, pictures, text, sound, games, applications or any combination thereof;

(ii) a user database comprising user identification information;

(iii) a connection module enabling the user to electronically communicate with one or more users in the user database to form social network friends;

(iv) an activity log associated with each user for saving in the user database the multimedia content programs currently viewed and the multimedia content programs viewed in the past by each user;

(v) a selection module adapted for receiving user input via an interactive electronic communication device, for selecting a multimedia content program to view either by searching the plurality of multimedia content programs or by selecting a multimedia content program referenced in the activity log associated with a friend;

(vi) an access module for accessing over an electronic communication network the selected multimedia content program;

(vii) a display for displaying the selected multimedia content program together with one or more sponsored messages;

(viii) an electronic revenue module for electronically crediting the user's automated bank resource with a first monetary revenue for watching one or more sponsored messages, and electronically crediting a user's friend automated bank resource with a second monetary revenue if the selected multimedia content program was selected from an activity log associated with the user's friends.

In some embodiments, the system further comprises a shopping database containing electronic references to shopping items for purchase associated with one or more multimedia content programs.

In some embodiments, shopping items purchased by a user are saved in the user's activity log.

In some embodiments, the electronic revenue module electronically credits a friend's automated bank resource with a third monetary revenue when a user selects and electronically purchases a shopping item for purchase from the friend's activity log.

In some embodiments, the plurality of multimedia content programs in the database are organized by channels.

In some embodiments, a multimedia content program can be electronically accessed for free, after paying a subscription fee or after paying a one-time fee.

In some embodiments, the multimedia content is accessed over the electronic communication network from a television, an interactive television, a computer, a laptop, a tablet, a game console, a smartphone or any combination thereof.

In some embodiments, the multimedia content is electronically displayed by a Web site, an application, a television channel or any combination thereof.

In some embodiments, a user can personalize the sponsored messages viewed.

In some embodiments, the first monetary revenue, the second monetary revenue or both can increase or decrease according to one or more parameters of a user profile.

In some embodiments, the parameters comprise revenue levels, demographic data, extent of viewing of sponsored messages or any combination thereof.

In another aspect, the present invention relates to a computerized plugin for electronically paying commissions to users of a social network for online shopping referrals, comprising:

(i) an access module for accessing over an electronic communication network an online merchant site, when a user selects a link to a post by a friend in a social network related to a purchased shopping item; and

(ii) an electronic revenue module for electronically crediting the friend's automated bank resource with a monetary revenue when the user makes a purchase at the online merchant site.

### BRIEF DESCRIPTION OF DRAWINGS

FIG. 1 is a block diagram of an embodiment of a system for multimedia content distribution.

FIG. 2 is a flowchart of an embodiment of a process for distributing multimedia content according to the invention.

FIG. 3 illustrates of an embodiment of display according to the invention showing different tabs and information screens along with the content program.

FIG. 4 is a flowchart of an embodiment of a process for crediting a referral for a shopping item purchased, according to the invention.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” means any one or more microprocessors, central processing units (CPUs), computing devices, microcontrollers, digital signal processors, or like devices.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on an Intel™ processor, that is adapted to communicate with the computer. Any number and type of machines may be in communication with the computer.

The present invention relates to an electronic system and method for distribution of multimedia content programs over an electronic communication network to a user in a social network. The social network enables users to register and connect with other users. Users get paid for watching content, by receiving a revenue share of the advertisements displayed in conjunction with (before, during, after) the selected content. A user may also browse the content watched by any of his friends (connections) on the social network, and choose to watch the same content. In this case, the user gets compensated for watch a content program (with advertisement) and the friend also gets compensated for the referral.

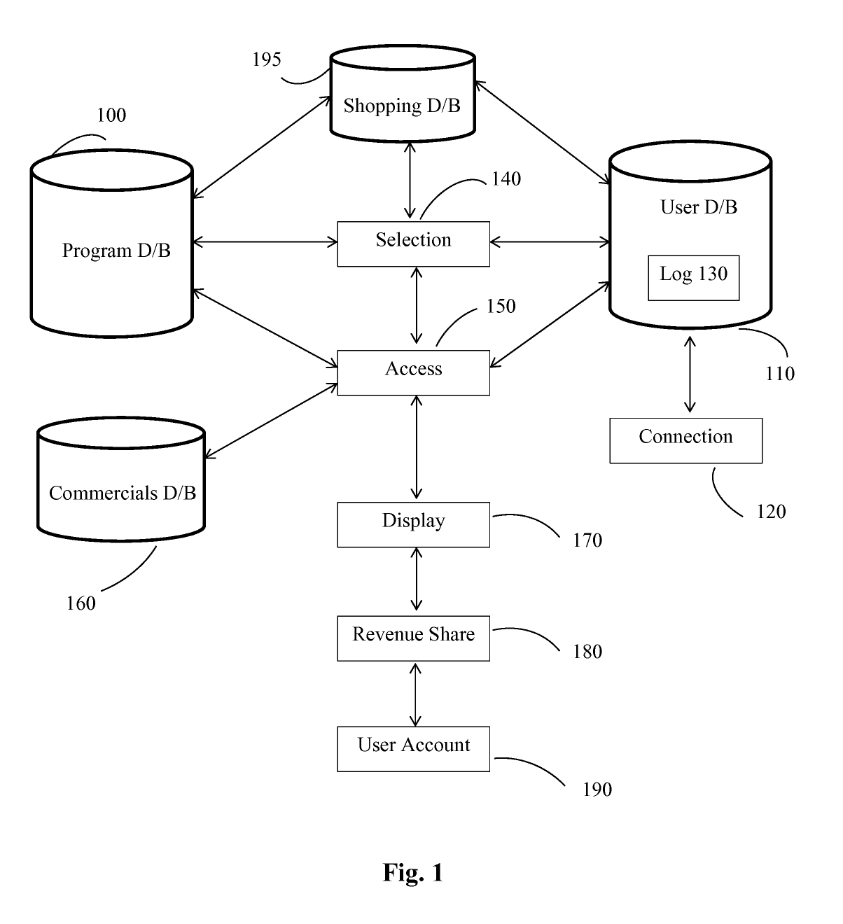

Reference is now made to FIG. 1 showing an embodiment of a system for distributing multimedia content programs according to the invention.

The multimedia content programs comprise video, graphics, animations, pictures, text, sound, games, applications or any combination thereof. The multimedia content programs are stored in a program database 100. The term “database” refers to a storage place for electronic data. A database is treated as one logical unit, though in practice a database can be distributed among several locations connected together via communications lines adapted for sending digital data.

The user gains access to the multimedia content programs via an electronic communication network such as the Internet, cable television lines, satellite communications lines, wired telephone lines, wireless telephone lines, wireless cellular lines, private or public network lines or any combination thereof.

A connection module 110 is configured to enable the user to electronically communicate with one or more users in the user database 100 of the social network to form social network friends.

Privacy levels can be defined by the connection module 110 so that each user can choose the level and detail of information he wishes to share with each of his connections. The term “friend” as used herein refers to two users that are electronically connected in the social network, regardless of the level of connection between them, and regardless if the two users actually know each other in the real world or not.

A special category of friends (also referred to as “followers”) is when the sharing is only in one direction. For example, John can see Jane's information, but Jane does not see John's information. This category is suitable, for example, for celebrities who wish to share their information with the public, but have no interest in sharing the public's information.

Users enter the social network of the invention to select and then access multimedia content. The social network of the invention is adapted to distribute all content programs currently delivered via a television, a computer, a game console, a smartphone, tablet, wearable technology (smart glasses, smart watch and the likes) etc., including but not limited to: television series, movies, news, animations, documentaries, entertainment shows, sports programs, educational programs, applications, games, pictures, music, sound recordings, text etc. The term “application” as referred to herein, means interactive computer programs that run on an interactive device with which the user accesses the multimedia content. Such interactive devices comprise a processor for executing the application, associated memory for storing the application, a selection module or device adapted to receive user input and a display screen. It is possible for the user to use several devices in order to access the multimedia content, for example, a user might use his smartphone or tablet computer in order to select the multimedia content program, but then have the multimedia content program display on a big screen television set instead.

A selection module 140 is adapted for receiving user input via an interactive electronic communication device, for selecting a multimedia content program from the program database 110 to view either from the plurality of multimedia content programs or from the activity log associated with a friend The available multimedia content in the program database 100 can be arranged into channels, favorites, playlists, history lists and any other arrangement form to facilitate user access. In addition, a user may perform a search for a multimedia content program using different search parameters. For example, if searching for a movie, it will be convenient to be able to search by name, actor, director, genre, year as well a free keyword search.

The social network includes a user database 110 comprising information regarding all the users registered with the social network. Typically, for each user, the user databases 110 maintains at least minimal identification information, for example, the user's real name and user's identification name in the system (username).

One of the purposes of a social network is to enable users to connect between them via the connection module 120 in order to share information, exchange comments, ratings etc. The invention enables the user to electronically communicate with one or more users in the social network via the connection module 120 in order to form social network friends. The level of information that is shared between two users and their communication rights with each other can be customized and defined by each user using the connection module 120. Each user can configure the privacy settings of any of his friends in order to determine what that friend can see of his activity and information, and how that friend is authorized to electronically communicate with him.

An activity log 130 is created for each user and saved in the user database 110. The activity log 130 contains for each user a list of the multimedia content programs currently viewed and the multimedia content programs viewed in the past by that user. In some embodiments, it is also possible for a user to specify what multimedia programs he intends to watch in the future, and such information will also be saved to the user's activity log 130.

After entering the social network, the user uses the selection module 140 in order to select via an interactive electronic communication device a multimedia content program to view. The selection module 140 offers the user to select a program to view via at least two different paths. A user can directly search the multimedia content programs available in the program database 100, for example, by browsing different available channels or by performing a search using different search parameters. Alternatively, a user can browse the activity log 130 associated with his friends and then decide to watch a multimedia content program one of his friends is currently viewing or has viewed in the past.

The interactive electronic communication device used for selecting multimedia content can be any known and future selection device, including but not limited to a computer mouse, a touch screen, a remote control, a smartphone, a keyboard, a keypad, a voice recognition module, a gesture recognition module or any combination thereof.

After the user has electronically selected the multimedia content program he wishes to access, a reference to the user's selection is electronically transmitted via a processor to the access module 150 for accessing over an electronic communication network the selected multimedia content program in the program database 100.

The access module 150 then electronically fetches the selected multimedia content program from the program database 100 along with one or more sponsored messages from the commercials database 160.

The user is then provided access over the electronic communication network to the selected multimedia content program together with one or more sponsored messages. The sponsored messages can be any form of advertisement and can come before, after and/or during the viewing of the multimedia content program.

The selected multimedia content program coupled with the sponsored messages is then viewed on a display screen 170, such as a television set, a computer, a laptop, a tablet, a smartphone, wearable technology (watch, glasses etc.) or any combination thereof.

Once the user has viewed the sponsored messages, an electronic revenue module 180 then electronically credits the user's automated bank resource 190 with a first monetary revenue for watching the sponsored messages associated with the selected multimedia content program. The bank resource 190 can be any establishment or account that accepts monetary transfer, for example, a bank account, a credit card, a debit card or any other account that can receive money transfer or any equivalent compensation that has a monetary value such as airline miles etc.

If the selected multimedia content program was selected from an activity log 130 associated with one of the user's friends, then the electronic revenue module 180 also electronically credits the user's friend automated bank resource 190 with a second monetary revenue.

The selected multimedia content is electronically displayed by a Web site, an application, a television channel or any combination thereof.

A shopping database 195 can be created, with electronic references to shopping items associated with a multimedia content program. When a user views a multimedia content program for which associated shopping items exist, the shopping items can be displayed so that the user may electronically purchase them.

Any such shopping items purchases will also be saved in the user's activity log 130.

When a user selects and electronically purchases a shopping item for purchase from a friend's activity log 130, the electronic revenue module 180 also electronically credits the user's friend automated bank resource 190 with a third monetary revenue.

The multimedia content programs in the program database 100 can be electronically accessed for free, after paying a subscription fee or after paying a one-time fee.

In some embodiments, a user can personalize the sponsored messages viewed. For example, a user might specify preferred categories, a user might provide personal information and preferences so that the commercial messages may better fit his profile. Alternatively, the user may be provided with a list of sponsored messages out of which he will need to make a selection which ones to watch.

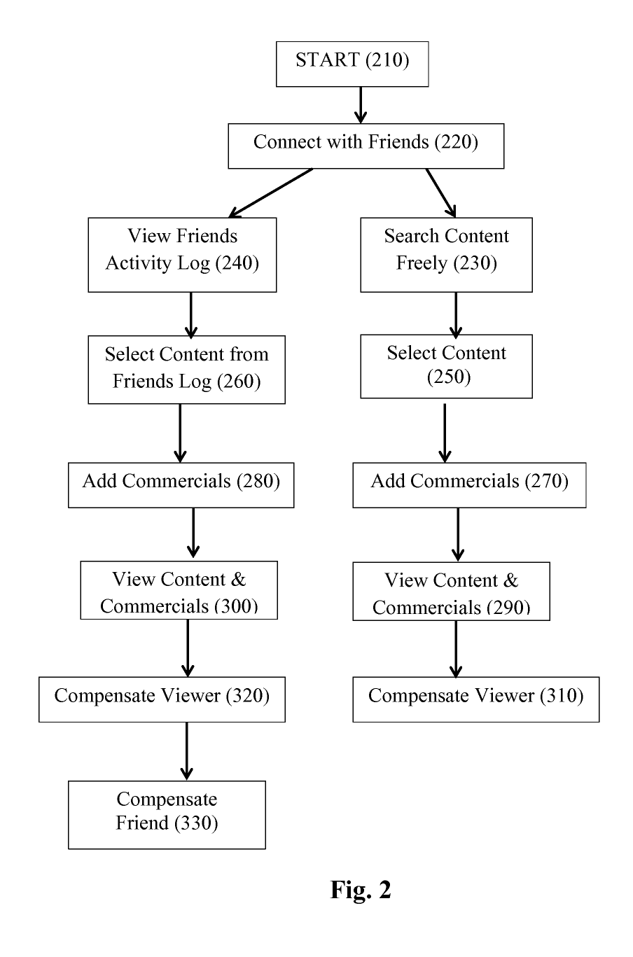

Reference is now made to FIG. 2 disclosing an embodiment of a method for distributing multimedia content according to the invention. The method starts in step 210. In step 220, the user can enter the social network and connect with other users. Connected users are termed friends, and are able to share information, view current or past activities, view future planned activities, leave comments, chat etc. All information about the users in the social network is stored in the user database 110, and the connection between users in handled by the connection module 120.

When enters the social network of the invention, he can search for a multimedia content program in two ways. In step 230, the user can search multimedia content programs freely. All multimedia content programs are stored in the program database 100, and can be arranged in many forms. For example, content channels can be presented organizing programs by topic (news, sports, documentaries . . . ) or provider (HBO™, Disney™, etc.). The search of step 230 can be performed by a variety of search parameters according to the desired multimedia content program. Examples of possible search criteria, include but are not limited to: actor, title, genre, director, release date etc. The search is performed by the selection module 140. Searching for content also comprises browsing through existing content channels, television guides or similar content guides, user recommendations, system recommendations etc.

Alternatively, in step 240, the user may browse or search his friends' content watching history. All the content that a user has watched or is currently watching is stored in an activity log 130 inside the user database 110. For example, a user might notice that his good friend has watched a certain movie or that a celebrity that he's connected to as a follower has watched a certain program. The browsing and searching of the activity log 130 is performed by the section module 140.

After the user has searched the multimedia content programs (either directly or through friends activity logs 130), the user selects the multimedia content program he wishes to watch. The selection is performed in step 250 for direct content searches made by the user (in step 230), and in step 260 for searches made through a friend's activity log 130 (in step 240). All the selections (steps 230 and 240) are performed by the selection module 140.

After a content program has been selected, in steps 270, 280 one or more commercials are selected, and then the user watches the multimedia content along with the selected commercials in 290, 300. The multimedia content program along with the associated sponsored messages (commercials) are fetched by the access module 150 over an electronic communications line, such as the Internet, cable television lines, satellite broadcasting lines, wired telephone lines, wireless telephone lines or any combination thereof.

The commercial messages are fetched by the access module 150 from a commercial database 160. The commercial messages can be placed before viewing the content and/or during the content program. The commercial messages can also be placed after viewing the content program though this is less effective as the user has no compelling reason the watch the commercial message after finishing watching the content program.

In steps 310, 320 the user gets a compensation for having watched the commercial messages (in steps 290, 300). The user compensation is handled by the Revenue Share module 180 by electronically crediting a user account 190.

If the user has selected a content program from a friend's activity log 130 (step 260), then in step 330, the user (friend) associated with the activity log 130 from which the content program was selected is also compensated for the referral.

It is important to notice that the compensation amounts allocated for each viewer and referral are flexible and can be customized to adapt to several scenarios, for example:
Each viewer receives (in steps 310, 320) the same compensation, regardless if the selection was done directly (step 250) or through a referral from a friend activity log 130 (step 250);
The compensation for a direct view (step 310) can be higher than the compensation for viewing through a referral (step 320);
The sum of the compensations is steps 320, 330 can be equal to the compensation in step 310;
The compensation in steps 310, 320 and/or 330 can increase or decrease according to the number and length of the commercial messages viewed;
The compensation in steps 310, 320 and/or 330 can increase or decrease by correlating the commercial message to user revenue levels, found in the user profile information. For example, a user with a higher household revenue might get a higher compensation for watching a commercial for a luxury product compared to a user with a lower household income (or no information about household income);
The compensation in steps 310, 320 and/or 330 can increase or decrease by correlating the commercial message to demographic data based on user profile information. For example, a user with young children might get a higher compensation for watching commercials for products for young children compared to a user with grown children, no children or no information about children;
The compensation in steps 310, 320 can increase the more a user watches commercials, in order to give users incentives for watching more commercials;
The compensation in steps 310, 320 can decrease the more a user watches commercials, in order to account for a saturation effect and also for the fact that a user has a given budget he can spend; and/or
The compensation in step 330 can increase the more referrals a user can create, in order to give users incentives for generating referrals.

It is also possible to combine any of the above compensation strategies along with new ones. A person skilled in the art, upon reading the above disclosure will immediately realize how to adapt and change the compensation strategy in a plurality of ways depending on available business data such as advertisers' profile, user base profile, revenue and cash flow targets and projections of the system of the invention etc.

The social network of the invention enables users to promote multimedia content programs they view, have viewed or intend to view. Once a user/viewer is viewing a content program, the user has the option of posting his viewing activity as a status on the social network. For example, when Tom is viewing a basketball game when a friend sees his name on the social network, Tom's name (or username used in the social network) will be accompanied with a small logo of the program (sports team, basketball, sports, NBA™ etc.). A friend who will place the curser/finger (or any equivalent pointing action) on Tom will be shown a popup with the relevant information regarding the basketball game. One option available for Tom's friend is to select a “Join View” option and also watch the game. The content program joined can be viewed either from the beginning or from the current point (that the friend is watching).

Once two users have “joined views”, and depending on the level of privacy rights defined, the users can chat and post/exchange comments about the program viewed.

This mechanism (“Join View”) will in fact, turn viewers to distributors of content programs by allowing their online friends to join in on their screenings. This effortless distribution by users, by simply posting their activity, will also have a financial impact. According to the invention, viewers get a revenue share from the ad revenue on the content item both for viewing, but also for enabling others to view through them (referrals). Once a friend clicks “join view” on their status, the referring user will generate a revenue.

The social network of the invention includes algorithms that create a “personal wallet” for each user. The wallet shows each user his revenue, both from viewing and from referring others to view what he is viewing, has viewed or intend to view. The user is able to see exactly how much each view/referral has earned him.

Currently, and for the past decades, the entertainment industry has a “pay per view” business approach: select a content program to view and pay for it either directly (subscription) and/or indirectly (cable TV fees etc.). The social network for distribution of multimedia content aims to reverse this model. According to the invention, selection of a program to view will generate the user revenue for viewing it (actually for watching the commercials shown with the content program).

Same goes for distribution. Currently copyrighted materials are forbidden for distribution by others. The invention aims to reverse this model and not only not to prohibit it, but to reimburse users for distributing content items. Essentially, the invention's business model alleges that there is more to be made by content producers (studios etc.) by giving money, than by taking money. This may sound absurd, but it isn't obvious. Today's technology has enabled us to change the current economic approach, and this change will be brought by technical instruments such as websites and applications, and we can see these changes are already happening everyday as the dominance of the web continues to increase.

The content distribution system of the invention reverses the “pay-per-view” model to a “paid-per-view/distribution model” Implementation of the invention has required digital entertainment understanding coupled with software engineering skills in order to integrate social viewing of multimedia content program along with tracking of commercial messages display and electronic revenue crediting to user accounts (bank accounts or equivalent financial accounts).

The present invention was conceived after conducting a research on the entire entertainment industry, to determine justification for the revenue-share model of the invention. The research included checking the current revenues of all 7 major media conglomerates that control 91% of the Media and entertainment industry in the United States: Viacom™, Disney™, NewsCorp™, Time Warner™, CBS™, Sony Entertainment™ and NBC Universal™, their revenue model (cinema, broadcast, cable, IP content delivery like Netfilx™, theme parks, merchandising etc.) the potential revenues they may lose due to the business model of the invention (cable revenues, for example) and the potential revenues they might earn from the distribution system of the invention. The research was also based on television viewing habits and ratings figures in America, piracy figures, online video consumption figures and growth, online video ads and growth potential, and figures on social activity on networks as well as many news articles concerning the full integration of Television and Web. These are amongst the many factors that contributed to the building of this system/method.

The social shopping model is an important addition to the content distribution. Next to each content program listing or icon a shopping tab/button is available with all the merchandising items relating to that content program. The same model of revenue share with the viewers also applies for shoppers. For example, a user finishing watching “Forrest Gump™” may want to click on a “Megastudioshop” tab where he can find all the merchandising items available for “Forrest Gump™”. Once a user purchases a shopping item, he will have the option of posting his activity as a “shopping status”, for example, “Tom just bought this hat from Forrest Gump™ (showing the purchased item with a small picture)” in the shopping feed. Shopping history is logged in the activity log 130 stored in the user database 110. Once one of the user's friends click on the shopping item and buys that same item, the referring user/shopper will electronically receive a revenue share.

In some embodiments, the revenue share through views/shopping is done in steps, meaning: for every view/shop referral a user gets x revenue share. Once a user gets to a certain amount of referrals, his compensation formula changes, whereas each referral would be worth more, either retroactively or for future referrals or any combination thereof. There can be more than one such step/goal to reach. The step can be based on the number of referrals, the revenue generated or a combination of these two factors.

There are many beneficiaries to the multimedia content program distribution system and method of the invention:

Advertisers will have a huge advertisements target public and have the option to perform targeted marketing based on user profile, demographics and history. Each sponsored message can thus have a stronger impact by being individually targeted to the right public, offering the ability to interact with the advertisement and go to the advertiser website and/or purchase the product or service advertised.

Regarding the public, people love entertainment and shopping, the system of the invention will allow them to get paid for it as well, and also to consume all the content without committing any piracy.

Content rights holders/media will position themselves as providers of content that is paid avoiding the tensions of online piracy of entertainment content, which will be reduced or become obsolete if the system of the invention becomes popular. The distribution system of the invention will also give their content tremendous exposure. According to some calculations, the joint revenues of all these media conglomerates in 2011 were around $150 Billion. The projection is that synergetic model of people distributing sponsored content will result in exponential growth and ultimately generating more than $1 Billion daily, all this without jeopardizing box office and TV revenues, as the supposed content will be available only after cinematic release and TV premiere. The distribution model of the invention will also benefit the content rights holders by letting them earn revenue from home entertainment distribution nationally as well as internationally. This synergetic model means that the media will operate together to the benefit of all. These corporations are estimated to double if not triple their revenues.

Every time a user views a content program or purchases a shopping item using the distribution system of the invention, the user will have an option to share his experience via social post, for example, “Tom is viewing . . . ”, “Tom viewed . . . ”, Tom just bought . . . 2 hours ago”, “Tom plans to view . . . on . . . ”, etc. The distribution system can be implemented via a Web site, an application (running on a telephone, computer, tablet or any other computing device), a service, interactive television or any combination thereof.

The social post can be posted on the social network of the invention and/or on other social networks such as Facebook™ or Twitter™. This is not uncommon as many sites carry the social icons of popular social networks so that people can post their comments/statuses on those external social networks without leaving the site in question.

In some embodiments, it can be advantageous for every post created by users in the social network of the invention, where the post promotes a certain content program or shopping item, to have a unique URL (Uniform Resource Locator, i.e. address) created, such that any revenues generated from it, can be identified and attributed to this URL. The URL creation can be done by integrating and automating a link building process with social plug ins, or in other words, taking the type of service exemplified by “https://bitly.com” and integrating it with the distribution service of the invention.

Social plugins enable a user to see what his friends have liked, commented on or shared on external sites. Namely, these are buttons that enable a user to perform a social network activity, including but not limited to: post a like, leave a comment, share an activity, share a 3^{rd} party post, follow etc. One example of social plugings can be seen at: “https://developers.facebook.com/docs/plugins”.

In computing, a plug-in (or plugin, extension) is a software component that adds a specific feature to an existing software application. When an application supports plug-ins, it enables customization. The common examples are the plug-ins used in web browsers to add new features such as search-engines, virus scanners, or the ability to utilize a new file type such as a new video format. Well-known browser plug-ins include the Adobe™ Flash Player, the QuickTime™ Player, and the Java™ plug-in, which can launch a user-activated Java applet on a web page to its execution a local Java virtual machine Δdd-on (or add-on) is the general term for what enhances an application. It comprises snap-in, plug-in, and theme. An extension add-on tailors the core features of an application by adding an optional module, whereas a plug-in add-on would tailor the outer layers of an application to personalize functionality.

The integration of the above URL and social plugins or add-ons can be called “Social Cookies”. Cookies are files created by websites a user has visited that store browsing information, such as a user's site preferences or profile information. There are two types of cookies: First-party cookies are set by the site domain listed in the address bar. Third-party cookies come from other domain sources that have items, such as ads or images, embedded on the page.

In another aspect, the present invention relates to a computerized plugin for electronically paying commissions to users of a social network for online shopping referrals. Technically, the plugin can come in different versions; where each version is configured to work with a specific Web browser.

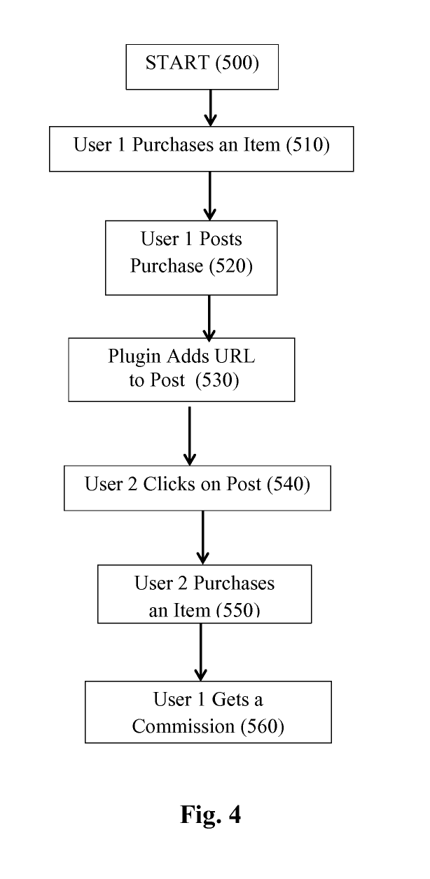

Reference is now made to FIG. 4 illustrating a flowchart of an embodiment of a sales referral process according to the invention. In step 510, a first user (user 1) makes an online purchase at a merchant site, for example, Amazon™ or Nike™. After completing the process, user 1 posts the purchase on one or more social networks. The user can select on which social network or networks to publish the post regarding the shopping item he purchased. The social network can included the social network for multimedia content distribution of the invention, as well as any other social networks the user is a member of, for example, Facebook™ or LinkedIn™. The post can include the name of the article purchased, an icon or an image of the article or a similar product, a rating provided by the user, comments provided by the user etc.

In step 530, the plugin of the invention turns the social post into a trackable “Social Cookie” by adding to it a distinctive URL (web address).

In step 540, another user (user 2) sees the post by user 1 in a social network and clicks on it (or any equivalent action). User 2 is then taken to the merchant site (online vendor) where user 1 has purchased from.

In step 550, user 2 makes a purchase of a shopping item at the same merchant site. The shopping item purchased by user 2 can be the same or different from the one purchased by user 1.

In step 560, the plugin credits the electronic bank resource of user 1 with a commission for the referral he has generated resulting in the purchased item or items by user 2.

User 2 has the possibility of now posting his own purchase (as in step 520), and he might also gain a referral revenue if any other user clicks on his post and makes a purchase at the same online vendor merchant site. In some embodiments, user 1 can also receive a commission for a referral made by user 2, since user 2 has made a purchase based on a referral from user 1.

The plugin of the invention comprises an access module for accessing over an electronic communication network an online merchant site, when a user selects a link to a post by a friend in a social network related to a purchased shopping item. For example, a user sees a post (in any social network) for a purchased item, and when he clicks on that post, the user is transferred to the merchant site.

The plugin further comprises an electronic revenue module for electronically crediting the friend's automated bank resource with a monetary revenue when the user makes a purchase at the online merchant site. When the user enters the merchant site as a result of clicking on link by a friend, any purchase of the user will generate a referral revenue to the friend who posted the link.

Using the plugin, a user can post his purchases in any social network or Web site that work with the plugin. The more places a user leaves his post, and the more friends and followers he has, the greater his chances for generating revenue when one his friends or connections clicks on his link and makes a purchase. It is also possible for a user to generate referral revenue from a user that is not a friend on the social network, as long as the social network enables that user to see the related shopping post.

The uniqueness of these social cookies is that they allow a detailed breakdown of the impact each social posting has regarding shopping/viewing, for example, the number of views and purchases a social post by a given user has generated. Currently, this information is mostly used by online marketers, but by turning each social post/status to a traceable, measurable link, it will turn users into actual marketers of content and retail items for purchase.

In some embodiments, a “social wallet” function is created to digitally store all references to revenues from referrals and viewings. The social wallet is actually the “Cookie Mater”, where the user can see exactly what his social cookies are yielding him.

Once other users click on the user's post/the newly created URL/social cookie, their action is logged under that social cookie's reference. Actions logged include but are not limited to: if these users have viewed commercials, how much it yielded the referring user; if they bought the same/other item by getting in to the online shop and completed a purchase within the same browsing session (got into the shop through the posted link by the referring user and completed a purchase of any item in the shop without closing their browser).

The concept of “Social Cookies” could also be valuable to specific online stores like Nike™, for example, if a user is shopping in the Nike™ shop online, and posts his shopping action on a social network, the user can go to his “social wallet” profile in the social cookies website, log in under his credentials and find out what his social cookies from various websites have earned him. This means that the social cookies model is applicable both for internal use by the entertainment viewing and shopping service, and external through all retailers using the social connect like button with the social cookie.

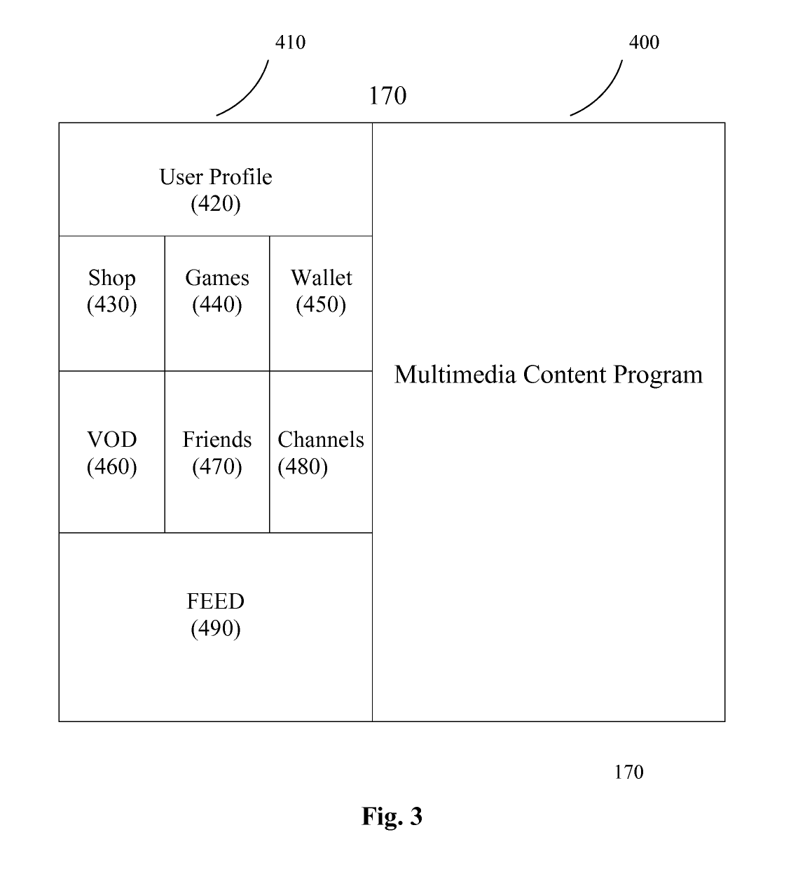

Reference is now made to FIG. 3 showing an example of how a display 170 can be visually and functionally organized. The available display area contains two main areas: a first (major) area 400 where the multimedia content program is displayed; and a second area 410 containing the social network functionality.

The content area 400 can display videos, games, television programs, web sites, applications, shopping zones etc.

The social network functionality area 410 can contain various buttons/tabs:

A user profile tab 420 can display the user's name, username, photo, key statistical data etc. From the user profile 420 tab/area the user can log/access into his account information to order to edit his personal data (demographic information, preferences, credit card, bank account etc.).

The feed 490 designates an area in the display 170 screen where custom information is displayed. The nature of information to be displayed is determined by the tab which the user has selected (selecting shopping, the feed 490 will show shopping data . . . ), as will be explained below.

When selecting the shop tab 430 the feed 490 shows a user the most recent shopping done by his friends. The user can post a “like” to the purchase, post a comment to the purchase, share the purchase information, or purchase these shopping items or other items from the same merchant site. Should a user purchase through a referral by clicking shop on the shopping post his friend did, the friend will get a revenue share as well. It is not important if the user has purchased the exact same item as his friend. As long as the user purchases anything from the merchant site (reached through the friend shopping status link), that friend will get an electronic revenue for the referral. The main screen are 400 could show either the content item which will keep playing, or alternatively a shopping screen showing the user merchandising items of recent commercials he saw or merchandising items related to different content items the user recently viewed.

When selecting the games tab 440 the feed 490 shows a user the recent game history of his friends such as games played, with whom the games were played (if relevant), scores, records broken etc. Similarly, the user can post a “like”, leave a comment or any other post regarding the game. By clicking a “join” option the user is able to join the game (if it's a network game) or simply play the game if it's a game for one person only. If the user does not own the game or have access to the game (for games played on the network, Internet etc.) the user is directed to download/register for the game. For games to be downloaded, the user is directed to an application store to download the game. A game may be downloaded for free or for a fee. For network based games, the user is directed to register for the game (again either for free or for a fee). When a user purchases a game based on a friend post, the friend will get an electronic monetary compensation for the referral.

When selecting the Wallet tab 450 the feed 490 shows a user the user's social cookies (daily, per item, monthly, yearly, charity donations and more revenue stats).

When selecting the VOD (Video on Demand) tab 460 the feed 490 shows the user information relevant to searching content programs freely (as described in step 230) and let the user select content to view (as described in step 250).

When selecting the friends tab 470 the feed 490 shows the user information relevant to friends activity log 130 (as described in step 240) and let the user select content to view from their friends activity log 130 (as described in step 260).

When selecting the friends tab 480 the feed 490 shows the user information available content channels offering multimedia content programs grouped by provider and/or genre.

It will be immediately obvious to any person skilled in the art upon reading the specification that the information presented in FIG. 3 can be implemented in different forms using common design tools. For example, a tab can be replaced by a button, an icon, a menu item or any selectable option. A menu can be fixed, partially viewed, can be made to disappear in order to view the content program in full screen etc.

Example of a Distribution Business Model

Prime time television in the United States places 8 minutes of commercials out of 30 minutes of content programming, on average. This means that on average anywhere between 12 and 18 commercials are aired per 30 minutes of content programming.

Online video commercials cost (the advertiser) anywhere between 3-10 cents per view.

According to these calculations, 8 commercials could generate approximately 50 cents of revenue on average.

Accordingly, if a user is viewing a 2-hour movie, this could be financed with 3-4 minutes of commercials throughout, for example, one minute in the beginning and another two minutes in the middle of the movie. In this case, the facilitator hosting the system of the invention still generates 50 cent from video commercials alone (not including additional revenues from pay per click through matching banners and pay per click which could generate more than $1). Traditionally, the majority of the revenues generated would go towards the content rights holders/media companies (again, the huge benefit for media companies).

With the content distribution system of the invention, users will view far less commercials compared to regular television, have access to a large amount of content (eventually, all content could be available via the system), generate revenue for watching the content, share the viewing experience with their friends. This user experience should be superior to today's piracy viewing, as users won't need to wait for a pirated download to finish, the quality of the viewing will be high and with no surprises, user would generate revenue and in some cases a portion of the revenues could be allocated to a charity cause supported by the viewer.

Celebrities will find the service very attractive as their participation can assist charities and thus boost their image. Users will enjoy knowing what their favorite stars are viewing. This could all lead to a predicted exponential growth ultimately producing more than 1 billion daily views, meaning potential revenues of more than $500 million daily, only from online video commercials. This is the ultimate benefit for media companies: doubling/tripling their revenues.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A method for distribution of multimedia content programs over an electronic communication network to a user in a social network, comprising:
(i) creating a program database with a plurality of multimedia content programs comprising video, graphics, animations, pictures, text, sound, games, applications or any combination thereof;
(ii) creating a user database comprising user identification information;
(iii) enabling the user to electronically communicate with one or more users in said social network to form social network friends;
(iv) saving in said user database for each user an activity log of the multimedia content programs currently viewed and the multimedia content programs viewed in the past;
(v) selecting by the user via an interactive electronic communication device a multimedia content program to view either from said plurality of multimedia content programs or from the activity log associated with a friend;
(vi) providing the user access over said electronic communication network to the selected multimedia content program together with one or more sponsored messages;
(vii) electronically crediting the user's automated bank resource with a first monetary revenue for watching said one or more sponsored messages;
(viii) electronically crediting a user's friend automated bank resource with a second monetary revenue if the selected multimedia content program was selected from an activity log associated with said user's friend.

2. The method according to claim 1, further comprising the step of electronically associating references for shopping items for purchase with one or more multimedia content programs.

3. The method according to claim 2, wherein a friend's activity log also contains shopping items purchased.

4. The method according to claim 3, wherein when a user selects and electronically purchases a shopping item for purchase from a friend's activity log, said friend electronically receives a monetary revenue.

5. The method according to claim 1, wherein said plurality of multimedia content programs in said database are organized by channels.

6. The method according to claim 1, wherein a multimedia content program can be electronically accessed for free, after paying a subscription fee or after paying a one-time fee.

7. The method according to claim 1, wherein said multimedia content is accessed over said electronic communication network from a television, an interactive television, a computer, a laptop, a tablet, a game console, a smartphone or any combination thereof.

8. The method according to claim 1, wherein said multimedia content is electronically displayed by a Web site, an application, a television channel or any combination thereof.

9. The method according to claim 1, wherein a user can personalize the sponsored messages viewed.

10. The method according to claim 1, wherein the first monetary revenue, the second monetary revenue or both can increase or decrease according to one or more parameters of a user profile.

11. The method according to claim 10, wherein said parameters comprise revenue levels, demographic data, extent of viewing of sponsored messages or any combination thereof.

12. An electronic system comprising a memory and processor for distribution of multimedia content programs over an electronic communication network to a user in a social network, comprising:
(i) a program database for storing a plurality of multimedia content programs comprising video, graphics, animations, pictures, text, sound, games, applications or any combination thereof;
(ii) a user database comprising user identification information;
(iii) a connection module enabling the user to electronically communicate with one or more users in said user database to form social network friends;
(iv) an activity log associated with each user for saving in said user database the multimedia content programs currently viewed and the multimedia content programs viewed in the past by each user;
(v) a selection module adapted for receiving user input via an interactive electronic communication device, for selecting a multimedia content program to view either by searching said plurality of multimedia content programs or by selecting a multimedia content program referenced in the activity log associated with a friend;
(vi) an access module for accessing over an electronic communication network said selected multimedia content program;
(vii) a display for displaying the selected multimedia content program together with one or more sponsored messages;
(viii) an electronic revenue module for electronically crediting the user's automated bank resource with a first monetary revenue for watching one or more sponsored messages, and electronically crediting a user's friend automated bank resource with a second monetary revenue if the selected multimedia content program was selected from an activity log associated with said user's friends.

13. The system according to claim 12, further comprising a shopping database containing electronic references to shopping items for purchase associated with one or more multimedia content programs.

14. The system according to claim 13, wherein shopping items purchased by a user are saved in the user's activity log.

15. The system according to claim 14, wherein said electronic revenue module electronically credits a friend's automated bank resource with a third monetary revenue when a user selects and electronically purchases a shopping item for purchase from said friend's activity log.

16. The system according to claim 12, wherein said plurality of multimedia content programs in said database are organized by channels.

17. The system according to claim 12, wherein a multimedia content program can be electronically accessed for free, after paying a subscription fee or after paying a one-time fee.

18. The system according to claim 12, wherein said multimedia content is accessed over said electronic communication network from a television, an interactive television, a computer, a laptop, a tablet, a game console, a smartphone or any combination thereof.

19. The system according to claim 12, wherein said multimedia content is electronically displayed by a Web site, an application, a television channel or any combination thereof.

20. The system according to claim 12, wherein a user can personalize the sponsored messages viewed.

21. The system according to claim 12, wherein the first monetary revenue, the second monetary revenue or both can increase or decrease according to one or more parameters of a user profile.

22. The system according to claim 21, wherein said parameters comprise revenue levels, demographic data, extent of viewing of sponsored messages or any combination thereof.

23. A computerized plugin for electronically paying commissions to users of a social network for online shopping referrals, comprising:
(i) an access module for accessing over an electronic communication network an online merchant site, when a user selects a link to a post by a friend in a social network related to a purchased shopping item; and
(ii) an electronic revenue module for electronically crediting the friend's automated bank resource with a monetary revenue when said user makes a purchase at said online merchant site.
